(19) United States
(12) Patent Application Publication
(10) Pub. No.: US 2011/0229333 A1
(43) Pub. Date: Sep. 22, 2011

(54) SHEAR WEB CONNECTION

(75) Inventor: Christian Flach, Schacht Audorf (DE)

(73) Assignee: REPOWER SYSTEMS AG, Hamburg (DE)

(21) Appl. No.: 13/049,291

(22) Filed: Mar. 16, 2011

(30) Foreign Application Priority Data
Mar. 22, 2010 (DE) 10 2010 003 114.3

(51) Int. Cl. F16B 11/00; B32B 37/02; F01D 5/14

(52) U.S. Cl. 416/223 R; 156/60; 403/265

(57) ABSTRACT

A shear web (10, 10′) with two shear web feet (11, 11′, 12, 12′) for the connection of a pressure side (35) with a suction side (36) of a wing (37), wherein the shear web (10, 10′) has a longitudinal extension (38), which is transverse to the extension of the shear web from the suction side (36) to the pressure side (35). Also, a corresponding wing (37) and a method for the production of a wing (37). The shear web wherein at least one shear web foot (11, 11′, 12, 12′) has two connection sides (13-16′) arranged on opposite sides of the shear web (10, 10′) transverse to the longitudinal extension (38). The wing (37) has a shear web (10, 10′) and a supporting body (18-18″), which is connected with a shear web foot.

### BACKGROUND OF THE INVENTION

The invention relates to a shear web with two shear web feet, wherein the shear web is provided for the connection of a pressure side with a suction side of a wing, wherein the shear web has a longitudinal extension, which is transverse to the extension of the shear web from the suction side to the pressure side. Furthermore, the invention relates to a wing with a corresponding shear web. Furthermore, the invention relates to the use of a supporting body for a wing for the connection of the suction side and the pressure side with a shear web as well as a method for the production of a wing.

Within the framework of this application, the term wing comprises a bearing surface of an airplane, a propeller of a helicopter and in particular a rotor blade of wind power plant. If a rotor blade is discussed in the following in particular in connection with the figure description, a bearing surface of an airplane or a propeller of a helicopter shall also be implied.

Wings that use an aerodynamic lift, in particular rotor blades of wind power plants, are put under considerable stress during operation. In order to be able to absorb in particular tensile forces, one or more shear webs are installed or respectively glued in between the pressure side and the suction side of the wing or respectively rotor blade, which extend from the inside of the shell of the wing on the pressure side to the shell of the wing on the suction side. A shear web hereby extends at least in sections along a longitudinal extension of the wing. The corresponding blade shells are hereby preferably reinforced by belts, which contribute to the increase in stability of the wings or respectively rotor blades. The shear webs are normally connected with the respective belts, which are arranged on the suction side or respectively the pressure side of the wings and extend at least in sections in the longitudinal extension of the wing. For the connection, the shear webs are normally adhered with the belts on one side with glass fiber mats. A resin is normally used for adhesion. This hereby results in an essentially rectangular angle at the connection point of the shear web with the belt. The stressing of the wings, or respectively the rotor blades, thus leads to considerable peel stresses, which can lead to a loosening of the shear web adhesion and can cause dents in the shells.

The production of wings, in particular rotor blades, is also very time intensive, since in particular the positioning of the shear webs on the belts is very involved and difficult.

### BRIEF SUMMARY OF THE INVENTION

The object of the present invention is to specify a more stable shear web connection in a wing as well as an option for efficiently realizing the production of the wings.

This object is solved through a shear web with two shear web feet for the connection of a pressure side with a suction side of a wing, wherein the shear web has a longitudinal extension, which is transverse to the extension of the shear web from the suction side to the pressure side, which is further developed in that at least one shear web foot has two connection sides arranged on opposite sides of the shear web transversally to the longitudinal extension. The longitudinal extension of the shear web is hereby in particular along the longitudinal extension of the wing.

Through the use of two connection sides arranged on opposite sides of the shear web, by means of which a connection, for example, to a belt can take place, a stronger connection is already achieved. In the case of the preferred arrangement of the connection sides at an angle to each other that is less than 180°, the peel stresses during loads are preferably correspondingly reduced.

The connection sides on the two opposite sides of the shear web are preferably provided on both shear web feet. A very stable connection can hereby be achieved both on the suction side as well as on the pressure side of the wing. The connection sides of the shear web or, respectively, of the shear web feet are oriented in particular not only transversally to the longitudinal extension of the shear web but also transversally to the extension of the shear web from the suction side to the pressure side. The connection sides of the shear web foot are preferably fork-like in cross-section transversally to the longitudinal extension with respect to each other. Two fork arms are preferably provided hereby. The connection sides are designed, in particular, in a flap-like manner, for example made of glass-fiber-reinforced plastic mats, which are provided with a corresponding resin.

The shear web foot is preferably at least partially complementary in shape with a supporting body that is wedge-shaped or curved in cross-section and/or a blade shell and/or a belt of a blade shell of the wing. The blade shell and/or the belt is hereby also in particular preferably at least in sections wedge-shaped or curved. In particular, the supporting body can be designed integrally with the blade shell and/or the belt. The shear web foot is preferably connected as a single piece with the shear web or as an attachment with the shear web. For example, a profile, for example an extrusion press profile, can serve as the attachment.

Furthermore, the object is also solved through a wing with a shear web according to the invention, which was described above, and a supporting body, which is arranged on the suction side or pressure side inside the wing, in particular on a belt, and is connected with a shear web foot. The supporting body hereby extends preferably longitudinally axially with the wing.

A supporting body, which is connected with one shear web foot respectively, is preferably arranged on the pressure side as well as on the suction side. Within the framework of the connection, “connected” means adhesion in particular.

The supporting body is preferably designed wedge-shaped or curved, in particular convex, in cross-section transversionally to its longitudinal extension. A form-complementary connection, i.e. a very well fitting connection to the shear web foot of the shear web according to the invention, can be achieved hereby. The wedge shape also includes in particular a wedge with rounded edges. The curved shape can be a polygon, in particular preferably with rounded edges, such as a triangle or a rhombus. A curved shape is also understood in particular as a Gaussian distribution or a similar curve form. The wedge preferably has an angle of 30° to 120°, in particular 50° to 90°, to the shear web.

The supporting body preferably has a density of less than 200 kg/m³, in particular less than 100 kg/m³, and in particular less than 35 kg/m³. The supporting body is preferably made of a foamed material, made of polyethylene, polystyrene, polyethylene terephthalate, balsa wood or glass-fiber reinforced plastic (GRP). In particular, the connection sides of the respective shear web foot are adhered to surfaces of the supporting body or respectively are connected with it.

The object is also solved through the use of a supporting body inside on the suction side and/or pressure side of a wing for the connection of the suction side and/or the pressure side with a shear web, which extends from the suction side to the pressure side, wherein the supporting body is arranged on a belt or is one piece with the belt. The arrangement of the supporting body on a belt also includes, in particular, a conjointness with the belt. The and/or each supporting body is preferably connected with a belt or is one piece with the belt. In this case, the belt has a corresponding supporting body, which is arranged in particular preferably longitudinally axially or respectively at least in sections longitudinally extended to the wing and is designed in cross-section transversally to its longitudinal extension wedge-shaped or curved, in particular convex.

The curvature or respectively the cross-sectional shape of the supporting body is also here a polygon, in particular with rounded edges like a triangle or a rhombus. The convex curvature is to be understood such that it, seen from the side on which the supporting body is arranged, is designed convex. Within the framework of the invention, the term longitudinal extension includes in particular preferably mainly or completely parallel to the longitudinal axis of the wing or respectively in the case of a bent and/or twisted wing along the longitudinally extending contour of the wing.

The object is also solved through a method for the production of a wing with a pressure side and a suction side, wherein at least one belt is provided on both the pressure side and on the suction side, wherein a supporting body is or will be applied to at least one belt, wherein a shear web according to the invention, which was described above, is adhered with a supporting body such that the supporting body is fitted between the connection sides of the shear web foot. In particular, the supporting body is adhered accordingly with the connection sides of the shear web foot. This measure makes possible the very fast and efficient positioning of the shear web between the blade shells or respectively shells of the wing. This also results in high process security. Mold occupation time is also saved since the shear web or the shear webs can be adhered wet-on-wet in two shell halves or respectively into the corresponding shell sections without intermediate drying. A shear web positioning also takes place through a type of self-centering of the shear webs. It is hereby ensured that the shear webs are always adhered at the correct belt position. A very complex and expensive positioning tool or positioning device is, thus, not needed.

A supporting body is preferably fitted between the connection sides of the shear web feet on each side of the shear web. Within the framework of the invention, this should also be understood the other way around such that the connection sides of the shear web sides are applied to the supporting body or respectively connected with them accordingly.

### BRIEF DESCRIPTION OF THE DRAWINGS

The invention is described below, without restricting the general intent of the invention, based on exemplary embodiments with reference to the drawings, whereby we expressly refer to the drawings with regard to the disclosure of all details according to the invention that are not explained in greater detail in the text. The drawings show in:

FIG. 1 a three-dimensional schematic representation of a shear web connection according to the invention,

FIG. 2 a schematic sectional representation of a shear web connection according to the invention,

FIG. 3 a schematic sectional representation of the production of a shear web according to the invention in a beginning process state,

FIG. 4 a schematic sectional representation of the production of the shear web according to FIG. 3 in an advanced process state,

FIG. 5 a schematic sectional representation of the production of a shear web according to FIG. 4 in a further advanced process state,

FIG. 6 a schematic sectional representation of the production of a shear web according to the invention in a further advanced process state compared to FIG. 5,

FIG. 7 a schematic sectional representation of a belt mold,

FIG. 8 schematically a cut through a shear web foot according to the invention, and

FIG. 9 schematically a cut of a representation of a shear web connection.

### DETAILED DESCRIPTION OF THE INVENTION

In the following figures, the same or similar types of elements or respectively corresponding parts are provided with the same reference numbers in order to prevent the item from needing to be reintroduced.

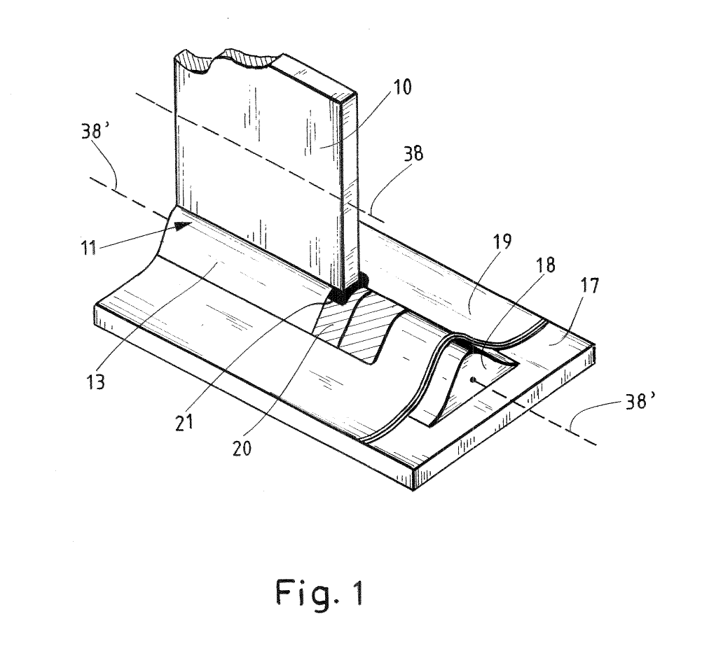

FIG. 1 shows a schematic three-dimensional representation of a shear web connection according to the invention. A supporting body 18, for example made of balsa wood or glass-fiber-reinforced plastic, is applied to a belt 17. A hardened plastic foam can also be used instead of this material. The supporting body 18 can also be produced integrally with the belt and can be made of the same material as the belt. However, in this exemplary embodiment, the supporting body 18 is adhered to the belt 17. The supporting body 18 has a longitudinal extension 38′, which is essentially parallel to the longitudinal axis of the rotor blade or respectively, under certain circumstances, can also be warped, bent and/or flexed like the belt and the rotor blade. The corresponding shape of the supporting body 18 along the longitudinal extension 38′ matches the shape of the wing or respectively the rotor blade on the corresponding blade shell, to which the belt 17 is attached.

In addition to the adhesion of the supporting body 18, laminate layers 19 are applied above the belt 17 and the supporting body 18 in order to provide a more secure connection. An adhesive 20 is applied to the laminate layers 19 and on the adhesive 20, which can be for example a resin, a supporting overlay 21 on the one hand and a connection side 13 on the other hand and on the other covered side a connection side 13′ is adhered above the supporting body 18. The connection sides 13 or respectively 13′ are components of the shear web foot 11 of the shear web 10. The shear web 10 has a longitudinal extension 38. FIG. 1 only shows one section of the correspondingly shown components. In the case of a wing or respectively a rotor blade, the longitudinal extension 38 or respectively 38 is naturally considerably larger than shown in FIG. 1.

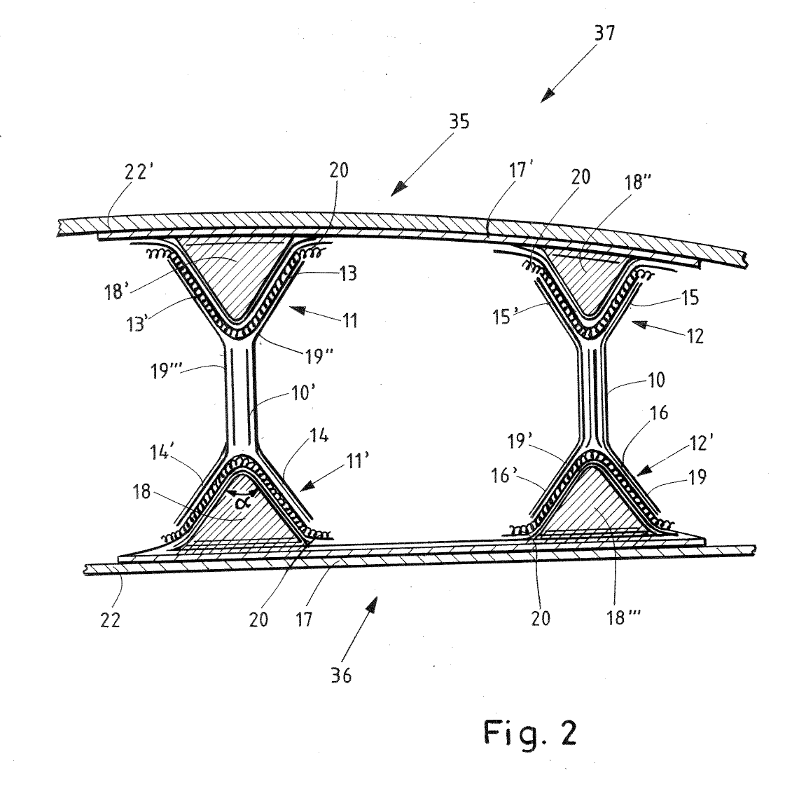

FIG. 2 shows a cut through a further shear web connection according to the invention, in which two shear webs 10 and 10′, which are provided between belts 17 and 17′ of the suction 36 and pressure side 35 of a rotor blade 37, are provided. The belt 17 is attached to the blade shell 22 of the suction side and the belt 17′ on the blade shell 22′ of the pressure side 35. The shear web 10 has two shear web feet 12 and 12′, each of which have connection sides 15 and 15′ or respectively 16 and 16′. The connection sides 15 and 15′ are connected with an adhesive 20 with the supporting body 18″ or respectively laminate layers arranged on the supporting body 18″ and, on the opposite side, the connection sides 16 and 16′ are correspondingly connected with an adhesive 20 with the supporting body 18′″. The same goes for the shear web 10′, for which a corresponding connection of the connection sides 13 and 13′ with the supporting body 18′ and the connections sides 14 and 14′ is provided with the supporting body 18. The supporting bodies 18 through 18′″ are correspondingly connected with belts 17 and 17′.

In a supporting body, namely the supporting body 18, an angle α is shown, which represents a wedge angle. It is approx. 60°. The supporting bodies here have the shape of a rounded wedge in the cross-section with a wedge angle α. The cross-section can also be considered curved, in particular convex. This also goes for the supporting body 18 of FIG. 1, which in cross-section shows a type of Gaussian distribution, i.e. a very harmonic curvature.

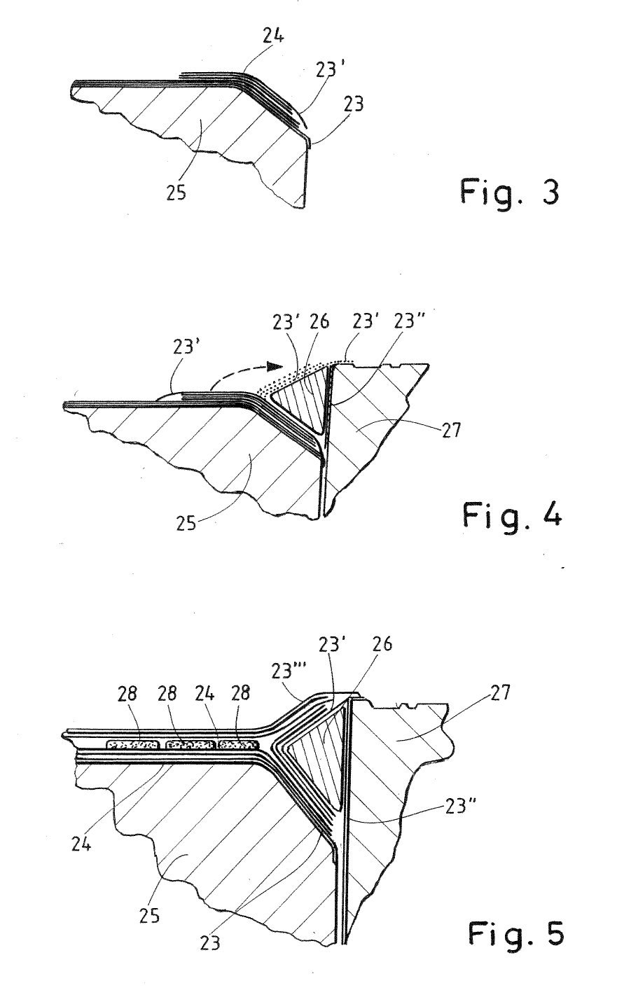

FIGS. 3 through 6 show schematically sectional representations through a part of the mold occupation during production of a shear web according to the invention. FIG. 3 shows a first mold 25, onto which a tear-off fabric 23 is applied as the first layer and then correspondingly several glass fiber layers 24 in different lengths. The end of these glass fiber layers forms a tear-off fabric 23′.

In the next step, which is shown in FIG. 4, a second mold body 26 is provided, which has a corresponding shape like a correspondingly supporting body to be used for connection and moreover a third mold body 27. First, another tear-off fabric 23″ is installed between the second mold body 26 and the third mold body 27 and potentially a flow aid, which is not shown. The tear-off fabric 23′ is then folded over in the direction of the arrow, wherein the arrow is dashed here, onto the second mold body 26 and partially onto the third mold body 27, and the shorter laminate layers 24 are then also correspondingly folded over. These laminate layers 24 then form a connection side after completion of the shear web.

FIG. 5 shows the shear web production in an advanced process stage. In the meantime, fill bodies 28 have been inserted into the shear web and further laminate layers 24 have been applied. The end of the laminate layers 24 applied on top forms a tear-off fabric 23′″.

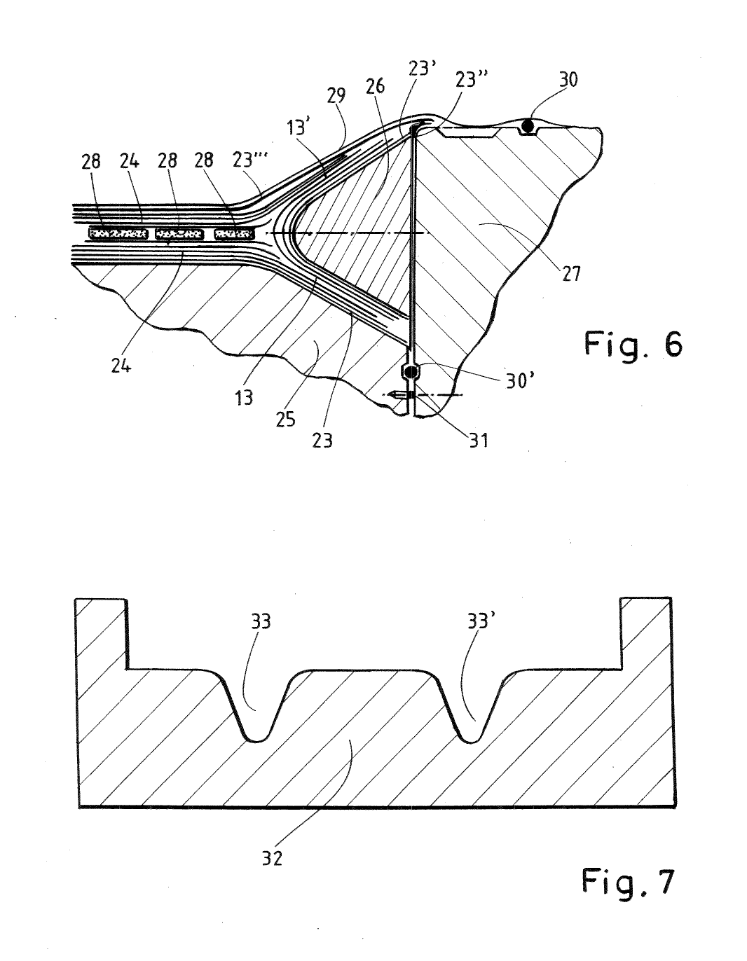

As shown in FIG. 6, a vacuum film 29 is applied in the end, which is applied in a sealing manner on a sealing band 30. Furthermore, a sealing band 30′ is provided between the first mold body 25 and the third mold body 27. A centering pin 31 or respectively a centering bolt 31 also serves here for better positioning.

The shear web is then preferably produced with an injection pressing technique (Resin Transfer Molding; RTM), an infusion technique (Resin Infusion Molding; RIM) and in particular a vacuum-supported infusion technique (Vacuum Assisted Resin Infusion; VAR). Accordingly, a normal laminating technique can also be used, for example using prepregs. In the exemplary embodiment according to FIGS. 3 through 6, a RIM or VAR process is preferably used.

In the case of the production of a wing or respectively rotor blade, a correspondingly produced shear web can be inserted into the corresponding blade shells before the complete drying of the used resin and connected with the respected belts or respectively mold bodies, which are arranged on the belts or respectively are integral with them.

FIG. 7 shows a belt mold 32, in which corresponding recesses 33, 33′ are already provided, which are provided for the formation of two supporting bodies on the belt or respectively are integral with the belt to be produced. Corresponding glass fiber mats or respectively glass fiber fabric can be inserted into the recesses 33 and 33′ as well as into the overlying belt mold recesses 33 and 33′ and saturated accordingly with resin as customary. Alternatively, a couple of glass fiber fabric layers can also be inserted first and a supporting body made of another material or respectively prefabricated supporting body can be inserted into the recesses 33 and 33′ as an intermediate step in order to subsequently apply glass fiber fabrics, which represent the respective belt after completion of production.

Within the framework of this application, other fabrics such as aramid fiber fabric or carbon fiber fabric can also be used instead of glass fiber fabric.

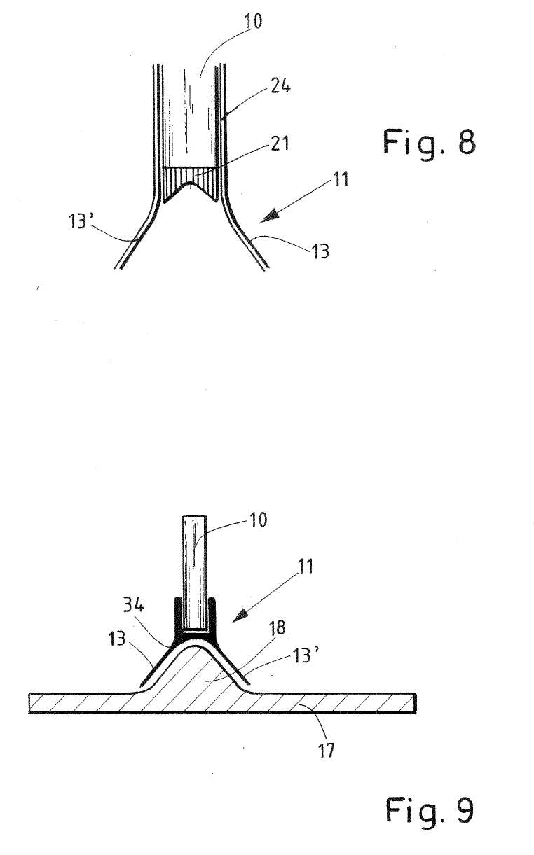

FIG. 8 shows schematically a sectional representation through a corresponding shear web foot of a shear web 10, wherein the connection sides 13 and 13′ are correspondingly identifiable. The connection sides 13 and 13′ are made of corresponding glass fiber layers 24, which are designed integrally with the glass fiber fabrics 24 of the shear web. A supporting overlay 21, which can for example be made of glass-fiber-reinforced plastic or balsa wood or a similarly stable and light material, is provided for supporting the shear web 10 on a corresponding supporting body (not shown) in order to increase stability.

FIG. 9 shows an alternative shear web 10 with a shear web foot 11, in which the shear web 10 is produced according to the current state of the art and is rectangular in cross-section. The shear web foot 11 has a foot profile 34, into which the shear web 10 is inserted, for example glued in or correspondingly screwed or riveted in. Moreover, the foot profile 34 has connection sides 13 and 13′, which are complementary in form to the supporting body 18, which is designed in this case integrally with the belt 17, i.e. the belt 17 has a corresponding shape, for which a corresponding supporting body is provided in sections. The supporting body is, in this case, also wedge-shaped in cross-section with rounded edges.

The supporting body including overlaminates are preferably applied together with the belt still in the belt mold with a RIM process. The separation stress can be minimized through selection of a hard supporting body. Instead of the production of the belt with supporting bodies, a normal belt that has setting devices for application of the supporting body can also be used.

The foot profile 34 from FIG. 9 can be, for example, an extrusion press profile from a resin/powder mixture. It can also be a glass-fiber-reinforced plastic profile that was correspondingly laminated.

The invention solves problems with the shear web adhesion of components produced using a shell construction like bearing surfaces and rotor blades and positively influences the denting resistance of the blade shells. The production of corresponding wings or respectively rotor blades according to the invention is very reliable and saves mold occupation time since the shear web or the shear webs can be adhered wet-on-wet into both shell halves without intermediate drying. Moreover, the shear web positioning involves a type of self-centering of the shear webs, which ensures that the shear webs are always adhered to the correct belt position. A very complex and expensive positioning tool is thus not needed.

All named characteristics, including those taken from the drawings alone, and individual characteristics, which are disclosed in combination with other characteristics, are considered alone and in combination as important to the invention. Embodiments according to the invention can be fulfilled through individual characteristics or a combination of several characteristics.

### LIST OF REFERENCES

10, 10′ Shear web
11, 11′ Shear web foot
12, 12′ Shear web foot
13, 13′ Connection side
14, 14′ Connection side
15, 15′ Connection side
16, 16′ Connection side
17, 17′ Belt
18, 18′, Supporting body
18″, 18′″
19, 19′ Laminate layer
19″, 19′″
20 Adhesive
21 Supporting overlay
22, 22′ Blade shell
23, 23′, Tear-off fabric
23″, 23′″
24 Glass fiber fabric
25 First mold body
26 Second mold body
27 Third mold body
28 Fill body
29 Vacuum film
30, 30′ Sealing band
31 Centering pin
32 Belt mold
33, 33′ Recess
34 Foot profile
35 Pressure side
36 Suction side
37 Rotor blade
38, 38′ Longitudinal extension
α Wedge angle

1. A shear web (10, 10′) comprising:
two shear web feet (11, 11′, 12, 12′) for the connection of a pressure side (35) with a suction side (36) of a wing (37),
wherein the shear web (10, 10′) further comprises a longitudinal extension (38), which is transverse to the extension of the shear web (10, 10′) from the suction side (36) to the pressure side (35), and
wherein at least one shear web foot (11, 11′, 12, 12′) has two connection sides (13-16′) arranged on opposite sides of the shear web (10, 10′) transversally to the longitudinal extension (38).

2. The shear web (10, 10′) according to claim 1, wherein both shear web feet (11-12′) have two connection sides (13-16′) each.

3. The shear web (10, 10′) according to claim 2, wherein the connection sides (13-16′) of the shear web foot (11-12′) are fork-like in cross-section transversally to the longitudinal extension (38) with respect to each other.

4. The shear web (10, 10′) according to claim 1, wherein each shear web foot (11-12′) is at least partially complementary in shape with a supporting body (18-18′″) that is wedge-shaped or curved in cross-section and/or a blade shell (22, 22′) and/or a belt (17, 17′) of a blade shell (22, 22′) of the wing (37).

5. The shear web (10, 10′) according to claim 1, wherein each shear web foot (11-12′) is one piece with the shear web (10, 10′) or is connected as attachment (34) with the shear web (10, 10′).

6. A wing (37) with a shear web (10, 10′) according to claim 1 and a supporting body (18-18′″), which is arranged on the suction side (36) or pressure side (35) inside in the wing (37), on a belt (17, 17′), and is connected with a shear web foot (11-12′).

7. The wing (37) according to claim 6, wherein a supporting body (18-18′″), which is connected with one shear web foot (11-12′) each, is arranged both on the pressure side (35) as well as on the suction side (36).

8. The wing (37) according to claim 6, wherein the supporting body (18-18′″) is designed wedge-shaped or curved, in cross-section transverse to its longitudinal extension (38′).

9. The wing (37) according to claim 6, wherein the supporting body (18-18′″) has a density of less than 200 kg/m3.

10. A use of a supporting body (18-18′″) inside on the suction side (36) and/or pressure side (35) of a wing (37) for the connection of the suction side (36) and the pressure side (35) with a shear web (10, 10′), which extends from the suction side (36) to the pressure side (35), wherein the supporting body (18-18′″) is arranged on a belt (17, 17′) or is one piece with the belt (17, 17′).

11. The use according to claim 10, wherein the supporting body (18-18′″) is arranged longitudinally and axially to the wing (37) and is designed wedge-shaped or curved, in cross-section transverse to its longitudinal extension (38).

12. A method for the production of a wing (37) with a pressure side (35) and a suction side (36), comprising the steps of:
providing at least one belt (17, 17′) on both the pressure side (35) and on the suction side (36),
applying a supporting body (18-18′″) to at least one belt (17, 17′),
adhering a shear web (10, 10′), with two shear feet and a longitudinal extension which is transverse to the extension of the shear web from the suction side to the pressure side, with a supporting body (18-18′″) such that the supporting body (18-18′″) is fitted between the connection sides (13-16′) of the shear web foot (11-12′).

13. The method according to claim 12, wherein a supporting body (18-18′″) is fitted between the connection sides (13-16′) of the shear web feet (11-12′) on each side (35 and 36) of the shear web (10, 10′).
